(19) United States
(12) Patent Application Publication
(10) Pub. No.: US 2002/0150515 A1
(43) Pub. Date: Oct. 17, 2002

(54) Rotary regenerative oxidizer with distribution wings

(76) Inventor: Ji-Hwan Pack, Inchon City (KR)

Correspondence Address: BAKER BOTTS L.L.P., 2001 ROSS AVENUE, SUITE 600, DALLAS, TX, 75201-2980, US

(21) Appl. No.: 10/031,759

(22) PCT Filed: May 17, 2001
(86) PCT No.: PCT/KR01/00806

(30) Foreign Application Priority Data
May 17, 2000 (KR) 2000/13896

(51) Int. Cl. B01D 53/00; F01N 3/00

(52) U.S. Cl. 422/168; 422/169; 422/173; 422/176

(57) ABSTRACT

The present invention provides a regenerative oxidizer in which a separator is disposed within the housing of said oxidizer whereby a rotor in center of said separator rotates in order to remove waste gases containing volatile organic compounds and odorous gases continuously. The flow direction of waste gases is controlled by said rotor thus enabling maintenance of constant temperature in heat media bed and catalyst bed.

The present invention relates to regenerative oxidizers, in particular to regenerative thermal oxidizers and regenerative catalyst oxidizers in which a separator is disposed within the regenerative oxidizer wherein the cylindrical center of this separator a so called rotor rotates in order to remove waste gases such as volatile organic compounds (V.O.C.) and odorous gases continuously.

The conventional processes for removing waste gases containing volatile organic compounds and odorous gases are physical-chemical processes, e.g. condensation method, oxidation method, absorbing method and wet scrubbing method. Recently biological treatment processes using micro-organisms have also been developed. But there are technical difficulties in applying biological treatment processes to waste gases having high concentrations of volatile organic compounds and odorous gases. Therefore catalyst oxidizing method or wet scrubbing method are more commonly used.

In general, regenerative catalytic oxidations processes are in wide use because they can remove pollutants at lower temperatures than direct thermal oxidation processes can, thus saving energy. But the usual regenerative catalytic oxidation process is a damper type oxidation method using a timer which repeatedly absorbs and discharges volatile organic compounds.

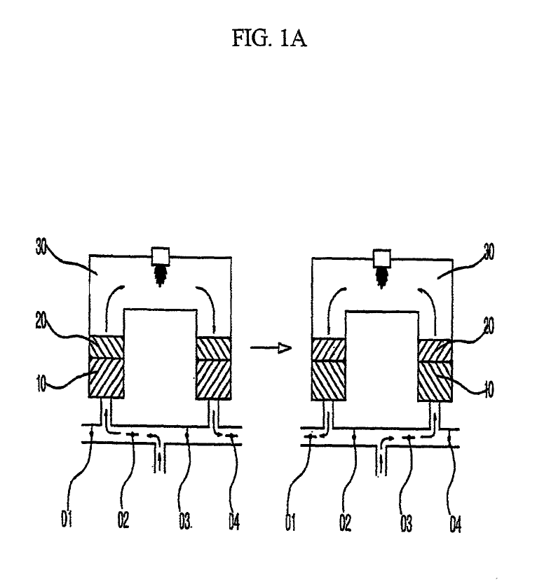

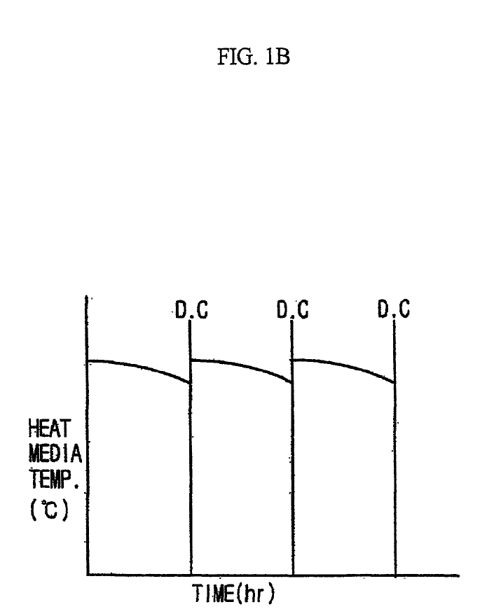

Therefore the regenerative catalytic oxidizer of the prior art, as shown in FIG. 1a, has dampers D2 and D4 serving as the inlet and outlet, respectively, for V.O.C. and is disposed at the lower section of the regenerative oxidizer, wherein the combustion chamber 30 is disposed in the upper section. Heat media bed 10 and catalyst bed 20, which recover the heat from the oxidized gas, are disposed within the regenerative oxidizer.

In the regenerative catalytic oxidizer as described above, V.O.C. are introduced into the regenerative oxidizer through damper D2 wherein V.O.C. are preheated as they pass through heat media bed 10 and catalyst bed 20. Then the preheated V.O.C. are removed in the combustion chamber. The purified high temperature gases pass catalyst bed 20 and heat media bed 10 disposed on the other side of the regenerative oxidizer and undergo a second oxidation in the catalyst bed and are discharged through damper D4 into the atmosphere whereby the heat is transferred to the heat media bed. The above described process is controlled by a timer disposed within the regenerative oxidizer which reverses the flow direction according to a fixed time interval, thereby changing the role of influent and effluent beds.

In other words, dampers D2 and D4 are closed and D1 and D3 are opened periodically according to FIG. 1a. Therefore the inlet becomes the outlet and vice versa. Although FIG. 1a shows a regenerative catalyst oxidizer, a regenerative thermal oxidizer operates in the same way and is also controlled by a timer.

At the time of switching dampers, however, after each cycle in a regenerative thermal oxidizer, untreated residual V.O.C. gases remaining between the heat media bed and the closed damper are discharged into the atmosphere when damper D1 is opened.

Additionally, in switching the dampers, the temperatures of the heat media bed and the catalyst bed decrease making the reheating of the burner to achieve the desired temperature necessary. Furthermore V.O.C. gases, which have not reached the desired temperature for oxidation, are discharged into the atmosphere untreated.

Considerable research has been done in this area in order to overcome this problem. The most representative approaches are described in U.S. Pat. Nos. 5,562,442 and 5,967,771.

U.S. Pat. No. 5,562,442 discloses a regenerative thermal oxidizer which consists of a lower, central and upper section, divided by a wall-like partition wherein the rotor is disposed in the center of the lower section. The rotor consists of upper plate assembly, aperture plate assembly and lower fixed surface. The aperture plate rotates against upper plate assembly using roller assembly which is secured by upper and lower sleeves.

In operation, the valve body rotates and receives gases from inlet and directs gases from inlet through apertures to the remainder of the oxidizer. Treated gas, then, is received in the rotary valve body through the aperture. In its rotation, the rotary valve body is supported by the adjustment assemblies relative to lower fixed surface and upper assembly.

But the aperture plate assembly rotates horizontally to the bottom plate of assembly. Therefore large covering area of sealing is required and complication and possibility of mechanical failure are involved. Thus a complete seal is not possible and increases manufacturing cost.

U.S. Pat. No. 5,967,771 discloses a rotary regenerative oxidizer which consists of more than two heat media beds and catalyst beds and a one-piece rotating element which is vertically disposed in the center of the regenerative oxidizer and is internally divided into three separate passages comprising dividing plates. The rotating element, comprising dividing plates, rotates as one-piece flow distributor.

In operation, the gases flow from inlet through the rotating element, into the inlet zone of the chamber and through the inlet section of heat media bed. The purified gases are forced through the other section of the heat media bed and then to the outlet.

In its rotation, as the rotation element and dividing plates rotates horizontally to the supporting part of the heat media bed 10, the sealing is required in the area between the three separate passage chamber and the one-piece rotating element and between the upper dividing plates and the bottom of the heat media section.

Therefore, the rotating element and three separated passage chambers require large cross sectional sealing area, resulting in increased manufacturing cost and the same sealing problem as in U.S. Pat. No. 5,562,442.

The aforesaid disadvantages are solved in accordance with a preferred constructed embodiment of the present invention by a regenerative oxidizer in which a separator is disposed within the housing of the regenerative oxidizer whereby the center of this separator rotates in order to remove waste gases such as volatile organic compounds (V.O.C.) and odorous gases continuously.

Thus the present invention provides a novel regenerative thermal oxidizer where V.O.C. gases pass through the heat media bed packed with ceramic material and are oxidized in the combustion chamber.

This invention also provides a novel regenerative catalyst oxidizer where a catalyst bed is added to the above mentioned heat media bed of the regenerative thermal oxidizer enabling oxidization of V.O.C. gases at lower temperatures.

Embodiments of the present invention will now be described by way of example, with reference to the accompanying drawings, in which:

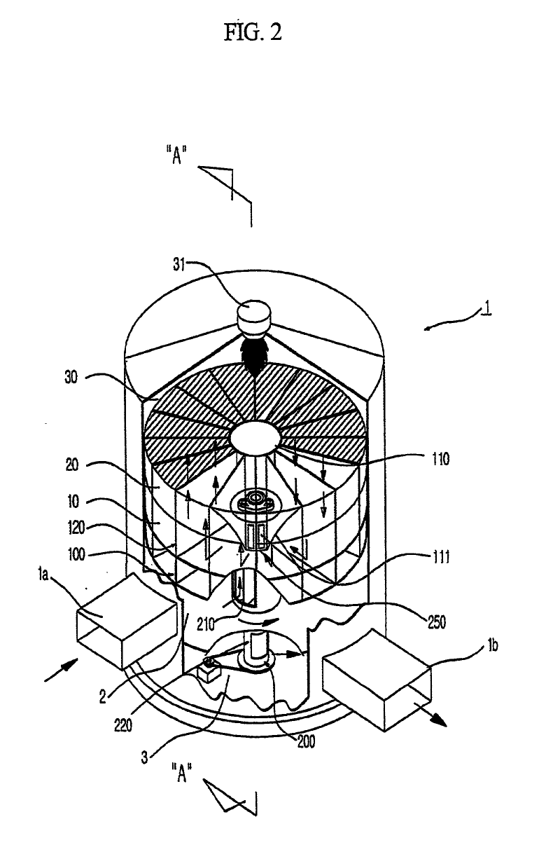

FIG. 2 is a schematic perspective view of the regenerative oxidizer of this invention;

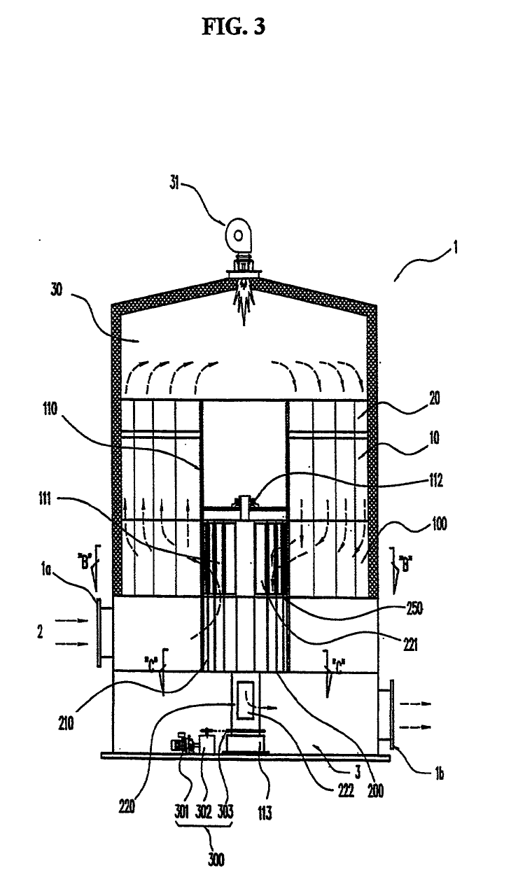

FIG. 3 is a schematic cross-section along the line “A-A” of FIG. 2;

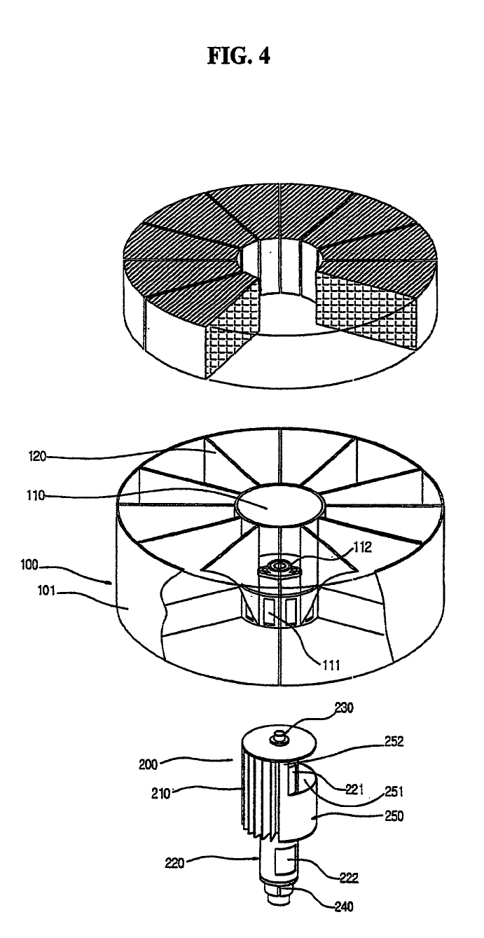

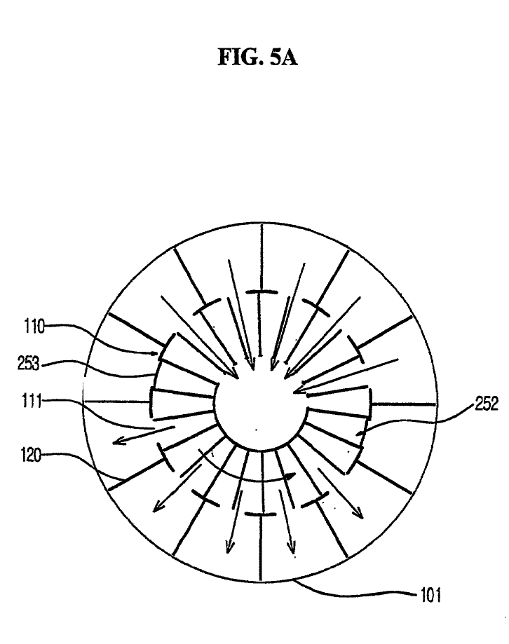

FIG. 4 is a schematic perspective view of the separator and rotor;

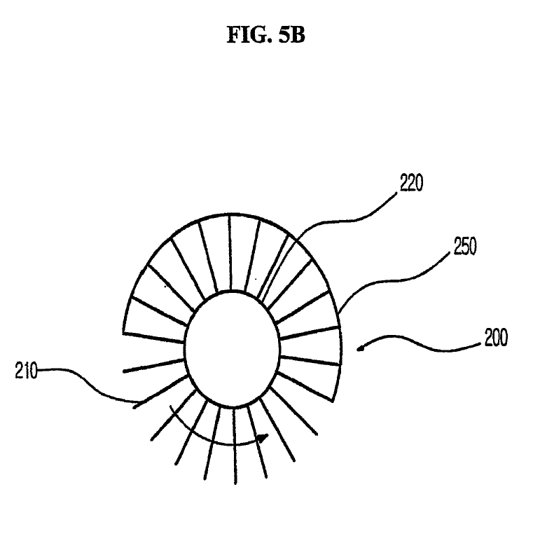

FIGS. 5a and 5b are schematic cross-sections along the lines of “B-B” and “C-C” of FIG. 3, respectively;

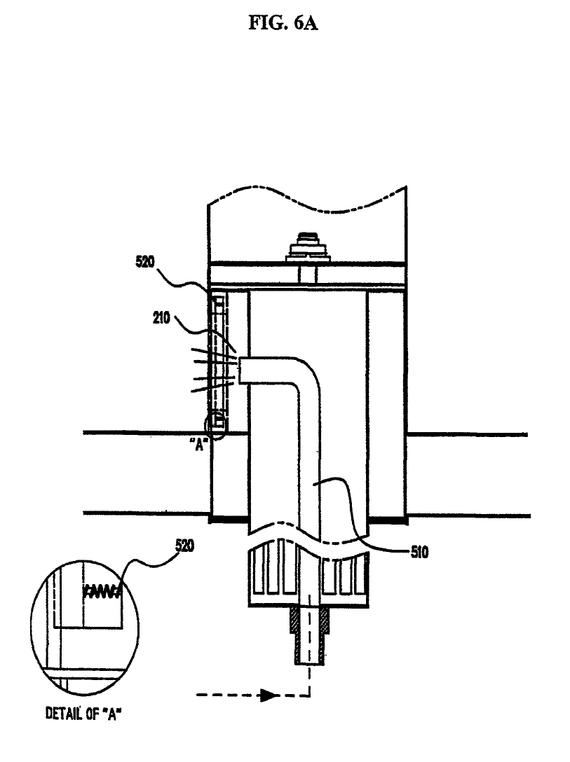

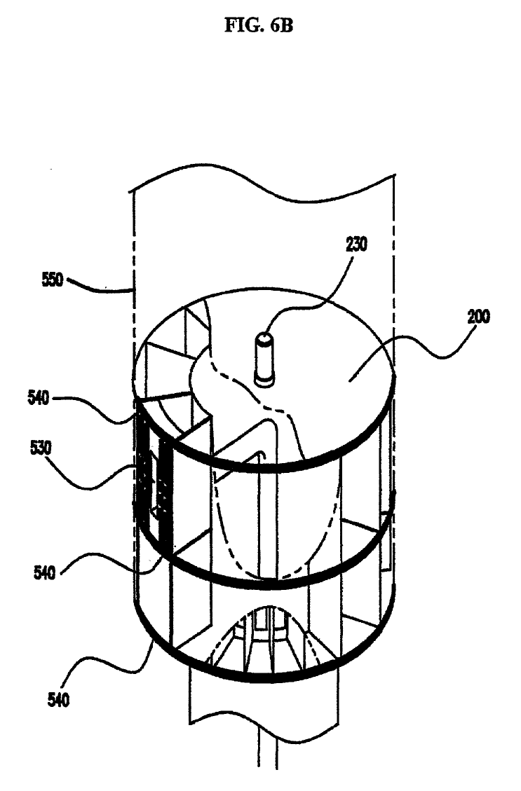

FIGS. 6a and 6b show the distribution zone equipped with a spring device and an O-ring in order to prevent the mixing of the influent and effluent gases.

In the Figures, the numerical number 1 indicates the regenerative oxidizer, 1a the inlet duct, 1b the outlet duct, 2 the inlet chamber, 3 the outlet chamber, 10 the heat media bed, 20 the catalyst bed, 30 the combustion chamber, 31 the burner, 100 the separator, 101 the outer wall, 110 the distribution cylinder, 111 the cylinder hole, 112 the upper bearing, 113 the lower bearing, 120 the isolating plate, 200 the rotor, 210 the distribution wings, 220 the rotor cylinder, 221 the upper outlet hole, 222 the lower outlet hole, 230 the upper axis, 240 the lower axis, 250 the rotor cover, 251 the outlet opening, 252 the vertical partition, 253 the purge section, 300 the driving method, 301 the gear motor, 302 the reducer, 303 the gear, 510 the purge gas supply line, 520 the spring device, 530 the fresh air purge, 540 the sealing device (“O”-ring), and 550 the separator's inner wall.

Although applicable to both regenerative catalyst oxidizers and regenerative thermal oxidizers, for convenience, the embodiments are described on the basis of a regenerative catalyst oxidizer.

Thus the term “regenerative oxidizer” used throughout this description means regenerative thermal oxidizer and/or regenerative catalyst oxidizer.

Cylindrical regenerative oxidizer 1 of FIG. 2 consists of duct 1a which serves as the inlet for waste gases such as V.O.C. and odorous gases, heat media bed 10 disposed circumferentially within the housing of regenerative oxidizer 1, catalyst bed 20 disposed circumferentially above the heat media bed, combustion chamber 30 equipped with burner 31 or electric heater where the combustion of gases takes place, distribution cylinder 110 disposed in the center of the housing, and separator 100 having cylinder holes 111 surrounding the distribution cylinder with isolating plates 120 which prevent the mixing of waste gases and purified gases.

The carrier in the heat media bed may consist of one or more of ceramic materials (honeycomb or saddle), metallic form or plate depending on specific application The catalyst bed may be charged with a catalyst such as Pt/TiO₂, manganese, chromium oxide, base metal, alumina, precise metal or combination thereof.

Separator 100 according to FIG. 4 consists of cylindrical outer wall 101, which fits to the inner wall of the oxidizer, and multiple cells divided by isolating plates 120 with equal spacing. The cell in the separator has a fan-shape form because of the difference between the circumference of the outer cylinder and the circumference of distribution cylinder 110. The upper section of the separator is in contact with the heat media bed and the lower section is isolated by inlet chamber 2 and outlet chamber 3.

Cylinder hole 111 serves as either an inlet or an outlet, according to the rotating position of the rotor, and has upper bearing 112 in the inner center that connects to upper axis 230 of rotor 200. That is, upper bearing 112 is connected to upper axis 230 of rotor 200 and lower axis 240 is connected to lower bearing (not shown in the figure) at the bottom of outlet chamber 3 to enable the rotation by driving method 300.

Rotor 200 is disposed within distribution cylinder 110 which consists of the following parts: rotor cylinder 220 which has multiple distribution wings 210 having equal spacing around the circumference, rotor cover 250 surrounding the distribution wings having a hole to collect the purified gases, outlet hole 222 connected to outlet duct 1b; and driving method 300 to let the rotor rotate under a specified velocity.

Rotor 200 consists of distribution wings 210 and upper outlet hole 221 and lower outlet hole 222. The rotor cover 250 covers vertically approximately one-half of distribution wings 210 and the bottom half of distribution wings 210 simultaneously. In other words, the rotor cover 250 covers approximately one-quarter of the circumference of distribution wings 210. The top half of distribution wings 210 is disposed within distribution cylinder 110. Therefore the lower section having distribution wings becomes the inlet for the waste gases and upper outlet hole 221 becomes the outlet for the purified gases.

Distribution wings 210 are disposed with equal spacing on the upper section of the rotor along the circumference and as mentioned above rotor cover 210 covers approximately one-half of the distribution wings. A lower plate (not shown in the Figure), which serves as a sealing, is located perpendicular to the rotor cylinder in the lower section of the rotor. Thus the mixing of waste gases and purified gases can be prevented.

The outlet opening 251 is located in the rotor cover 250 which overlaps with separator 100 allowing convenient discharge of the purified gases and preventing waste gases and purified gases mixing before they pass through upper outlet hole 221. The lower section of separator 100 where the waste gases are introduced is separately sealed by means of sealing device 540 in order to get complete sealing from rotor cover 250.

On each side of outlet opening 251 according to FIG. 5b is a vertical partition 252 of the rotor cover which prevents mixing of waste gases and purified gases in cylinder hole 111 while waste gases and purified gases are continuously introduced and discharged. Vertical partition 252 is broader than the width of the perforated cylinder hole in the circumference of the distribution cylinder. It opens and closes the cylinder hole according to the rotation of the rotor.

In a preferred embodiment there is a separate purge section 253 which is disposed within the rotor between the influent distribution zone and the effluent zone.

In another preferred embodiment sealing can be applied to the gap between the surface of separator's inner wall 550 and the distribution wings 210 by physical, pneumatic or hydraulic means in order to prevent the mixing of waste gases and purified gases as shown in FIG. 6. Sealing materials such as high-tension Teflon and spring devices can be installed in this gap as shown FIG. 6a. In order to enhance sealing of rotor 200 and inner surface of separator 100, a sealing device 540, such as O-ring can also be used. This O-ring is installed in the upper section of the rotor 200, the lower section of the rotor cover 250 and bottom of outlet opening 251 as shown in FIG. 6b.

Driving method 300 consists of gear 303 and reducer 302 whereby the connection means between the rotor and the driving method may be a chain or a belt.

Ia operation, and in accordance with FIG. 3, waste gases are introduced via inlet duct 1a. These gases flow into rotor 200 which is disposed within regenerative oxidizer 1 and are distributed by distribution wings 210 to separator 100.

Therefore approximately one-half of the distribution wings becomes the inlet and the other half becomes the outlet. Through the rotation of rotor 200, cylinder hole 111, which is disposed in the center of separator 100 serves as the inlet for waste gases or as the outlet for purified gases depending on the rotor position.

Waste gases introduced to the distribution wings that are not covered by rotor cover 250 pass stepwise through separator 100, heat media bed 10 and the catalyst bed 20, and are eventually oxidized in the combustion chamber. The purified gases pass stepwise through the catalyst bed 20, the heat media bed 10 and the separator 100 on the other side of the oxidizer. Then the purified gases pass through outlet opening 251 of rotor 200 and upper outlet hole 221 and are introduced to the inner section of rotor cylinder 220. These gases pass through the lower outlet hole 222 and are discharged via outlet duct 1b into the atmosphere.

Waste gases containing V.O.C. and odorous gases flow through cylinder hole 111 in the distribution cylinder 110 disposed in the center of the separator 100 and are distributed into the zone divided by the separator 100. Then these gases flow to heat media bed 10 and catalyst bed 20. The influent gases absorb the heat from the purified gases and pass preheated heat media bed 10 and catalyst bed 20 and then are oxidized by burner 31 or electric heater with minimal heat at the temperature of 200˜400° C.

In the absence of the catalyst bed, i.e. for a regenerative thermal oxidizer, the temperate of the combustion chamber may be maintained at 760˜850° C.

The purified gases pass through the heat media bed 10 by giving away its heat, thereby raising the temperature of the heat media bed. These gases pass cylinder hole 111 and upper outlet hole 221 and lower outlet hole 222 disposed in rotor cylinder 220. Then the purified gases flow to outlet chamber 3 and are discharged through outlet duct 1b.

Rotor 200 is driven by gear motor 301 and regulator 302 at certain speed by means of controlling-device such as inverter. As described above, the in and outflow of the gases are regulated by the rotor, and the function of the heat media bed and the catalyst bed is reversed according to the position of the rotor. Therefore a constant temperature can be maintained for each location of the heat media bed and the catalyst bed enabling the preheating of waste gases and oxidation with minimal heat.

The vertical partition section 252 of the rotor cover 250 on each side of outlet opening 251 according to FIG. 5a prevents mixing of waste gases and purified gases in cylinder hole 111 while waste gases and purified gases are continuously introduced and discharged.

Because vertical partition section 252 is broader than the width of the perforated cylinder hole in the circumference of the distribution cylinder, it opens and closes the cylinder hole according to the rotation of the rotor. If waste gases are introduced into a cell of the separator divided by isolating plates and purified gases are discharged from the neighboring cell, sharing of the hole by both cells is prevented. When either the discharge or introduction of gases is completed, the process continues to the next step, therefore avoiding the mixing of waste gases and purified gases.

According to FIG. 5b which shows a cross-section of inlet chamber 2, waste gases flow in through distribution wings 210 not covered by rotor cover 250 and purified gases introduced into upper outlet hole 221 of rotor cylinder 220 flow within rotor cylinder 220 and are discharged through lower discharge hole 222. These gases are discharged through the outlet duct disposed in discharge chamber 3 into the atmosphere.

Moreover, the lower isolating plate (not shown in FIG. 5b), which isolates rotor cover 250 and rotor cylinder 220, prevents the mixing of waste gases with purified gases.

As shown in FIG. 5, this invention was described on the basis of rotor cover 250 having distribution wings 210 inside, but rotor cover 250 without distribution wings may also function in the same way.

With consideration to the rotation direction of the rotor, there is a purge section 253 disposed in the opposite side of vertical partition 252. When waste gases are introduced into the fan-shape type separator cell divided by isolating plates 120 according to the rotation of the rotor 200, and purified gases are passing the same side of the separator, waste gases remaining in the heat media bed 10 and the catalyst bed 20 can be discharged into the atmosphere together with purified gases through cylinder hole 111. In order to prevent this, there is a purge for this overlapping section.

A purge gas supply line 510 is added to center of the distribution wing 210 according to FIG. 6a. Ambient air or purified air can be used as purge gas, supplied by a fan. The purpose of using purge gas is to blow down untreated waste gases in the heat media bed 10 and catalyst bed 20 to the combustion chamber 30 while rotor 200 rotates in sequence. The purged gas is then discharged as purified gas through the outlet distribution plate.

Through the repetitive inflow of waste gases and discharge of purified gases performed by rotation of rotor 200 and distribution wings 210, the influent and effluent zones overlap at cylinder hole 111, resulting in mixing of these gases. This vertical partition 252 serves to avoid this mixing.

Sealing can be applied to the gap between the surface of separator's inner wall 250 and the distribution wings 210 in order to prevent mixing of waste gases and purified gases as shown in FIG. 6. The sealing positions are illustrated on FIGS. 6a and 6b.

As described above, the present invention provides a novel regenerative oxidizer having a rotor disposed in the center of the housing enabling complete oxidation of waste gases and continuous and efficient operation. Furthermore, by controlling the flow direction of waste gases using rotor constant temperature can be maintained in heat media bed and catalyst bed thus saving energy.

1. A regenerative oxidizer, for removal of pollutants from waste gas comprising:
an elongated housing having an inlet duct and an outlet duct;
a heat media bed disposed circumferentially within the housing;
a combustion chamber equipped with a burner or electric heater;
a distribution cylinder disposed in the center of the housing;
a separator which is in contact with the heat media bed and the lower section isolated by the inlet chamber, and
a rotor disposed within the distribution cylinder.

2. A regenerative oxidizer as in claim 1 wherein a catalyst bed is disposed circumferentially above the heat media bed.

3. A regenerative oxidizer as in claim 1 wherein the separator consists of a cylindrical outer wall which fits to the inner wall of the housing and is divided into multiple cells by isolating plates.

4. A regenerative oxidizer as in claim 1 wherein the rotor consists of a rotor cylinder having multiple distribution wings, a rotor cover surrounding the distribution wings and an outlet hole connected to the outlet duct.

5. A regenerative oxidizer as in claim 4 wherein the distribution wings, having an upper and lower outlet hole, are disposed with equal spacing in the upper section of the rotor along the circumference and approximately one-half of of the said distribution wings are covered by a rotor cover.

6. A regenerative oxidizer as in claim 1 wherein a separate purge section is disposed within the rotor between the influent distribution zone and the effluent zone.

7. A regenerative oxidizer as in claim 1 wherein a vertical partition is disposed within the rotor on the other side of a purge section.

8. A regenerative oxidizer as in claim 1 wherein the gap between the surface of the separator's inner wall and the distribution wings are sealed by physical, pneumatic or hydraulic means.

9. A regenerative oxidizer as in claim 8 wherein the sealing means are Teflon, spring devices or O-rings.

10. A method for removal of pollutants from waste gases comprising the steps of:
(a) providing a regenerative oxidizer having an elongated housing with an inlet duct and an outlet duct, a heat media bed disposed circumferentially within the housing, a combustion chamber equipped with a burner or electric heater, a distribution cylinder disposed in the center of the housing; a separator which is in contact with the heat media bed and the lower section isolated by the inlet chamber; and a rotor disposed within the distribution cylinder;
(b) causing incoming waste gases to flow via inlet duct into rotor and are distributed by distribution wings to separator,
(c) causing the waste gases to flow upwardly through the heat media bed and be treated in the combustion chamber,
(d) causing the purified gases to flow downwardly through heat media bed;
(e) causing the purified gases pass through the rotor and to the inner section of rotor cylinder,
(f) causing the purified gases pass through lower outlet hole of rotor and discharge via outlet duct into the atmosphere.

11. A method for removal of pollutants from waste gases as in claim 10 wherein a catalyst bed is disposed circumferentially above the heat media bed.

12. A method for removal of pollutants from waste gases as in claim 10 wherein a separate purge section is disposed within the rotor between the influent distribution zone and the effluent zone.

13. A method for removal of pollutants from waste gases as in claim 10 wherein a vertical partition section is disposed in the opposite side of the purge section within the rotor.
